(19) United States
(12) Patent Application Publication
(10) Pub. No.: US 2003/0146314 A1
(43) Pub. Date: Aug. 7, 2003

(54) Moveable granulating container

(76) Inventors: Eugene McNally, Ringoes, NJ (US); Glenn Charles Snow, Sandy Hook, CT (US)

Correspondence Address: Janik Marcovici, PERMAN & GREEN, LLP, 425 Post Road, Fairfield, CT, 06824, US

(21) Appl. No.: 10/337,815

(22) Filed: Jan. 7, 2003

Related U.S. Application Data
(60) Provisional application No. 60/354,649, filed on Feb. 6, 2002.

(51) Int. Cl. B02C 19/12

(52) U.S. Cl. 241/100

(57) ABSTRACT

A granulating machine for granulating a substance. The granulating machine has a support with a container removably coupled to the support. The container has an interior region and an opening. The container is adapted to contain the substance. A lid removably covers the opening of the container. An impeller is in the interior region of the container. The impeller is adapted to mix the substance in the container. A chopper is in the interior region of the container The chopper is adapted to chop the substance in the container. The container is adapted to be removed from the support without removing the lid from the container.

### CROSS-REFERENCE TO RELATED APPLICATIONS

This application claims priority from U.S. Provisional Application No. 60/354,649, filed Feb. 6, 2002, which is incorporated by reference herein in its entirety.

### BACKGROUND OF THE INVENTION

1. Field of the Invention

The present invention relates to a moveable granulating container and, more particularly to a granulating machine having a moveable granulating container.

2. Prior Art

Granulating machines and devices having granulating containers are known in the granulating art. For example, DIOSNA, Dierks and Sohne, GmbH of Osnabruck, Germany markets and sells a mixing and granulating machine where the mixing container can be removed from the tool. In general, to remove the container from the tool, the cover of the container must be removed to access fasteners. The containers are removed from the tool for operations such as charging the container with granulating solutions, active powders or bulking agents or alternately removing the granulated substance from the container or alternately, taking samples from the container. In certain circumstances, such as in the case where potent drugs are being developed, the cover may not be removed as excess toxins or air born material may be discharged. Accordingly, there is a desire to provide a granulating machine having a granulating container where the granulating container may be removed from the granulating machine while still maintaining a sealed environment within the container.

### SUMMARY OF THE INVENTION

In accordance with one embodiment of the present invention, a granulating machine is provided for granulating a substance. The granulating machine has a support with a container removably coupled to the support. The container has an interior region and an opening. The container is adapted to contain the substance. A lid is provided removably covering the opening of the container. An impeller is provided in the interior region of the container. The impeller is adapted to mix the substance in the container. A chopper is provided in the interior region of the container The chopper is adapted to chop the substance in the container. The container is adapted to be removed from the support without removing the lid from the container.

In accordance with another embodiment of the present invention, a granulating enclosure for granulating a substance is provided. The granulating enclosure has a container having an interior region and an opening. The container is adapted to contain the substance. A lid is removably covering the opening of the container. An impeller is provided in the interior region of the container. The impeller is adapted to mix the substance in the container. A chopper is provided in the interior region of the container. The chopper is adapted to chop the substance in the container. The container is adapted to be moved from a first location where the substance is granulated to a second location without removing the lid from the container.

In accordance with another embodiment of the present invention, a granulating enclosure for granulating a substance is provided. The granulating enclosure has a container having an interior region and an opening. The container is being adapted to contain the substance. A lid is provided removably sealing the container. An impeller is provided in the interior region of the container. The impeller is adapted to mix the substance in the container. A filter is provided and adapted to allow a gas to escape from the interior region when the container is covered. The container is adapted to be moved from a first location to a second location without removing the lid from the container.

In accordance with another embodiment of the present invention, a method of granulating a substance is provided comprising steps of placing the substance into a container and then covering the container with a lid. Steps of then mixing the substance in the container at a first location with an impeller and chopping the substance in the container with a chopper are then provided. The step of moving the container from the first location to a second location without removing the lid from the container is then provided.

### BRIEF DESCRIPTION OF THE DRAWINGS

The foregoing aspects and other features of the present invention are explained in the following description, taken in connection with the accompanying drawings, wherein:

FIG. 1 is a side view of a granulating machine and a flow hood;

FIG. 2 is a schematic section view of the granulating machine shown in FIG. 1;

FIG. 3 is a schematic section view of a granulating enclosure.

### DETAILED DESCRIPTION OF THE PREFERRED EMBODIMENT

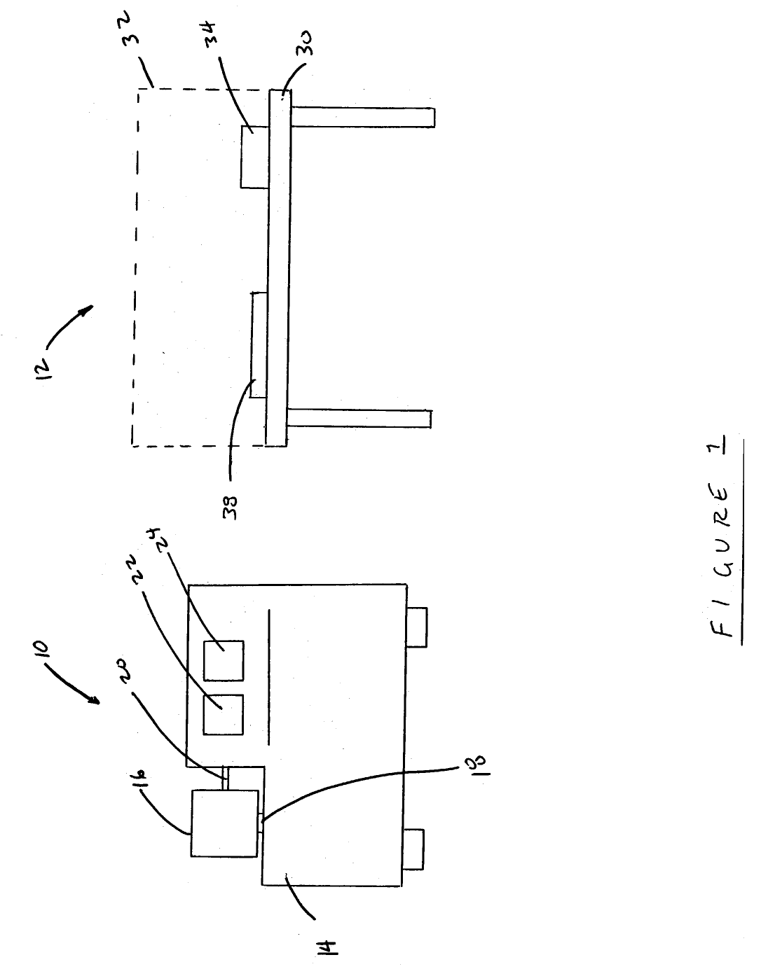

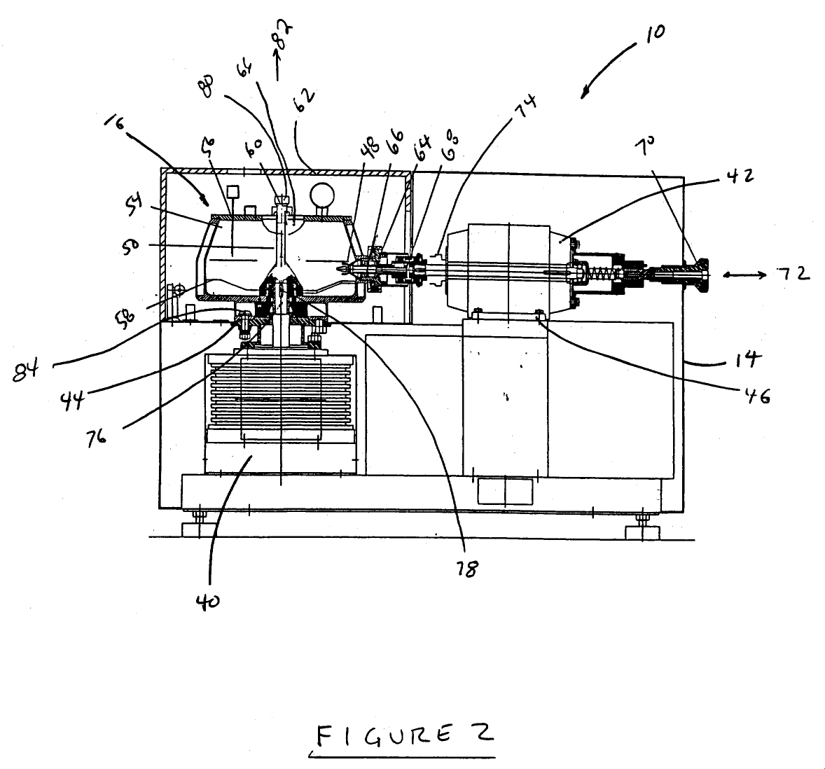

Referring to FIG. 1, there is shown a side view of a granulating machine 10 in accordance with teachings of the present invention and a flow hood 12. Although the present invention will be described with reference to the single embodiment shown in the drawings, it should be understood that the present invention can be embodied in many alternate forms of embodiments. In addition, any suitable size, shape or type of elements or materials could be used. A granulating machine may be adapted to mix and granulate substances such as powders and/or liquids in a container or enclosure 16. Such powders and/or liquids may be powder components, granulating solutions, bulking agents or active ingredients in the form of powder, liquids or atomized liquids. The granulating machine 10 shown in FIGS. 1 and 2 is merely an example of a suitable granulating machine and the present invention is equally applicable to any granulating machine or any suitable processing apparatus. Alternately, a granulating machine 10 of the type shown may be adapted to mix and/or granulate other types of substances. A flow hood 12 may be adapted for charging or inspection of granulated substances, such as for in process testing and may be further adapted for discharging or drying granulated substances where the granulated substances are in a container or enclosure. Alternately, a flow hood 12 may be any station adapted to further process, package, stage, store or otherwise be in a process or method sequence for containers or enclosures 16 containing granulated substances or other substances. One example of such a method, sequence or process may be as follows:

a) Charge container 16 with substance(s) in flow hood 12

b) Secure the lid on container 16 to seal container 16

c) Transfer container 16 to granulation machine 10

d) Couple container 16 to granulation machine 10

e) Granulate the substance in container 16

f) Uncouple container 16 from granulation machine 10

g) Transfer container 16 to flow hood 12

h) Remove lid from the container 16

i) Discharge granulation from container 16

The granulating machine 10 has a support 14 and a container or enclosure 16. Container or enclosure 16 may be coupled to the support 14 by one or more of couplings 18 and 20. The granulating machine 10 has user interface 22, 24 where an operator may start, stop or otherwise operate the garnulating machine. Container or enclosure 16 may be used to contain a substance or mix of substances such as such as powders and/or liquids. Support 14 is used to support container 16 and may house drive assemblies that are used to drive impellers or choppers used to granulate substances in the container 16. One or more of couplings 18 and 20 may be used to removably couple container or enclosure 16 to support 14 such that container or enclosure 16 may be removed from the support 14 and thus machine 10 in order to be transported to flow hood 12 or other station. The containers 16 may need to be removed from the machine 10 for operations such as charging the container 16 with granulating solutions, active powders or bulking agents or alternately removing the granulated substance from the container 16 or alternately, taking samples from the container 16. In certain circumstances, such as in the case where potent drugs are being developed, container 16 is sealed during removal from machine 10 and transport to flow hood 12 or other station in order to prevent excess toxins or air born material from being discharged from container 16. Flow hood 12 has a support 30, a hood 32, and may have equipment 34, 38 within hood 32. Hood 32 may incorporate a controlled air flow and filtration such that toxins, vapors or air born particles within hood 32 may not escape. In this manner, sealed containers may be placed within hood 32 and opened without the concern for contamination of the environment outside hood 32.

Referring to FIG. 2, there is shown a schematic section view of the granulating machine 10 shown in FIG. 1. The granulating machine 10 has a support 14 and an enclosure 16. A protective cover 62 may cover enclosure 16 during operation of the machine. Enclosure 16 has a container 54 and a lid or cover 56 that covers opening 66 of container 54. Inside of container 54 is impeller 50 having an impeller blade 58 that is used to mix substances in container 54. Impeller blade 58 rotates about axis 60 in order to mix substances in container 54 and for bulk distribution of substances in container 54. Inside of container 54 is chopper blade 48 that is used to chop substances in container 54. Although impeller blade 58 and chopper blade 48 are shaped, oriented and placed as shown, any suitable shape, orientation and/or placement may alternately be used. Chopper blade 48 rotates on shaft 66 about axis 64 in order to chop substances in container 54. Chopping motor 42 and mixing motor 40 are mounted to support 14 at mounting flanges 46 and 44 respectively. Chopping motor 42 rotationally drives chopper 48. Power is transmitted from chopping motor 42 to chopper 48 via shaft 66 through spline coupling 68. In an alternate embodiment, any other suitable coupling could be used. The drive shaft of motor 42 is axially moveable by pushing or pulling handle 70 in direction 72. When the drive shaft of motor 42 is axially moved to position 74 as shown, spline coupling 68 disengages its mating spline on shaft 66 allowing enclosure 16 to be decoupled from support 14. Mixing motor 40 rotationally drives impeller 50 via shaft 76 and key 78. In an alternate embodiment, any other suitable coupling could be used. Impeller 50 has a mating bore and keyway to couple to shaft 76 and key 78 of motor 40. Fastener 80 extends into shaft 76. Fastener 80 is shown as a screw, but in an alternate embodiment could be any suitable fastener. When fastener 80 is decoupled form shaft 76, allowing enclosure 16 may be lifted in direction 82 to be decoupled from support 14. Although not required, one or more bolts 84 may be provided coupled to support 14 and engaging open ended kidney shaped slots in container 54. In the event one or more bolts 84 are provided, enclosure 16 may be lifted in direction 82 to be decoupled from support 14 only after rotating enclosure assembly 16 about axis 60 until bolts 84 are disengaged from container 54.

In the embodiment shown, to remove enclosure assembly 16 from support 14, the following steps may be performed;

a) Axially move the drive shaft of motor 42 to position 74 to decouple shaft 66;

b) Loosen fastener 80 from the drive shaft of motor 40;

c) Rotate enclosure assembly 16 about axis 60 until bolts 84 are disengaged from container 54;

d) Lift enclosure assembly 16 in direction 82 and remove enclosure assembly 16 from support 14.

In this manner, enclosure assembly 16 may be removed from support 14 where the lid or cover 56 does not have to be removed from enclosure assembly 16.

In the embodiment shown, to replace enclosure assembly 16 to support 14 after removal, the following steps may be performed;

a) Place enclosure assembly 16 opposite direction 82 on support 14;

b) rotate enclosure assembly 16 about axis 60 until bolts 84 are engaged with container 54;

c) Tighten fastener 80 to the drive shaft of motor 40;

d) Axially move the drive shaft of motor 42 from position 74 to couple shaft 66.

In this manner, enclosure assembly 16 may be replaced on support 14 where the lid or cover 56 does not have to be removed from enclosure assembly 16.

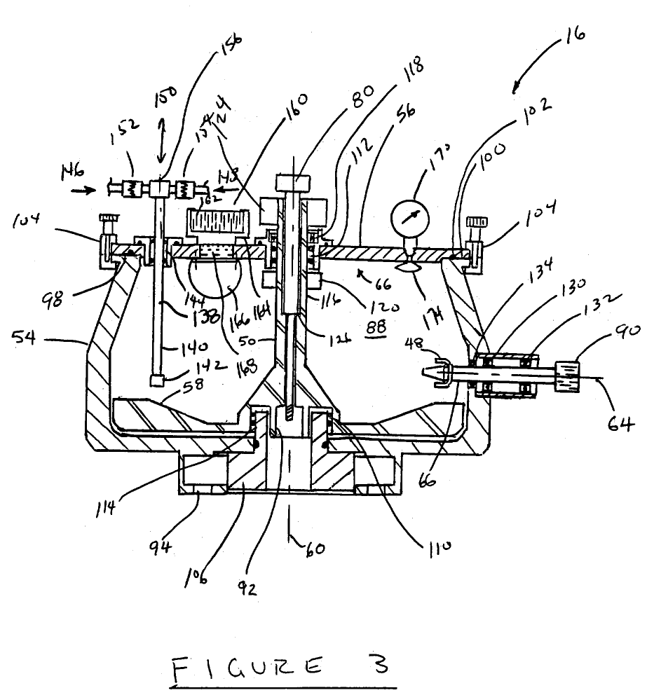

Referring to FIG. 3, there is shown a schematic section view of a granulating enclosure 16. Enclosure 16 has a container 54 and a lid or cover 56 that covers opening 66 of container 54 and isolates interior region 88. Container 54 may be made from stainless steel, metal, plastic or any other suitable material. Lid or cover 56 may be made from stainless steel, metal, plastic or any other suitable material or may be made clear from a material such as acrylic or glass in order to allow the operator to view the granulation without removing lid or cover 56. Container 54 has a sealing flange 98 which mates with sealing face 100 of lid or cover 56. A static seal 102 that may be an o-ring, gasket or otherwise may be provided to further seal the enclosure 16. In an alternate embodiment, no seal may be provided. Clamps 104 are provided to positively couple lid or cover 56 to container 54. In an alternate embodiment, fasteners or other wise may or may not be provided as an alternate to clamps 104. Container 54 has open ended kidney shaped slots 94 to allow removable coupling to support 14 (not shown). In an alternate embodiment, no such slots need be provided. A sealing flange 106 is provided coupled to container 54. A static seal 108 that may be an o-ring, gasket or otherwise may be provided to further seal the enclosure 16. In an alternate embodiment, sealing flange 106 may be fabricated as part of container 54 or may not be provided at all.

Inside of container 54 is impeller 50 having an impeller blade 58. Impeller 50 may be made from stainless steel, metal, plastic or any other suitable material. Impeller blade 58 may have one or a plurality of blades and rotates about axis 60. Impeller 50 has a mating bore 92 and key way (not shown) to couple to motor 40 (not shown). Fastener 80 extends through impeller 50 into the shaft of motor 40 (not shown). Fastener 80 is shown as a shoulder type screw that seats on shoulder 126, but in an alternate embodiment could be any suitable fastener or not provided as in the case where motor 40 (not shown) would couple with impeller 50 with, for example a spline type coupling. Impeller 50 is dynamically sealed to container 54 at dynamic seal 110 and to lid or cover 56 at dynamic seal 112. Dynamic seals. 110 and 112 are each shown as dual lip type seals that seal on diameters 114 and 116 respectively. Alternately, dynamic seals 110 and 112 may be o-rings, labyrinth seals, gas or fluid seals, clearance seals such as with a packing, bushing or other suitable seals. In alternate embodiments, more or less seals may be provided as in the case where dynamic seals 110 and 112 are single seals or multiple seals or no seals may be provided. In alternate embodiments, different geometry seals may be provided such as face seals or cone seals. Pilot bearing 118 may be provided to pilot impeller 50 in cover 54 as in the case when cover 54 is removed with impeller 50 in place. Pilot bearing 118 may be a ball bearing, bushing or other suitable pilot. In alternate embodiments, no pilot bearings may be provided. Collars 120 and 124 may be provided to position impeller 50 relative to cover 54 as in the case when cover 54 is removed with impeller 50 in place. In an alternate embodiment, no collars may be provided. Collar 124 may also serve as a heat sink to dissipate heat build up as a result of bearing or seal friction.

Inside of container 54 is chopper blade 48 that rotates on shaft 66 about axis 64. Power is transmitted from chopping motor 42 (not shown) to chopper 48 through mating spline 90 on shaft 66. In alternate embodiments, any suitable coupling may be used. Shaft 66 is supported by bearings 130 and 132. Bearings 130 and 132 may be ball bearings, bushings or other suitable bearings. In alternate embodiments, more or less bearings may be provided. Shaft 66 is dynamically sealed to container 54 at dynamic seal 134. Dynamic seal 134 is shown as a single lip type seal that seals on the outside diameter of shaft 66. Alternately, dynamic seal 134 may be an o-ring, labyrinth seal, gas or fluid seal, clearance seal such as with a packing, bushing or other suitable seal. In alternate embodiments, more or less seals may be provided as in the case where dynamic seal 134 are multiple seals or no seals may be provided. In alternate embodiments, a different geometry seal may be provided such as a face seal or cone seal.

Atomizing assembly 138 is shown extending through cover 56. Although atomizing assembly 138 is shown extending through cover 56, it could alternately extend through container 54 or otherwise. In an alternate embodiment, atomizing assembly could not be provided. Atomizing assembly 138 is provided to allow addition of an atomized liquid to the granulation while the granulation is being mixed or granulated allowing for a uniform mixture. Atomizing assembly 138 has extension 140, nozzle 142, liquid supply 148 and air supply 146. Liquid supply 148 may be a granulating solution or otherwise. Air supply 146 is mixed at approximately 7 psi with liquid supply 148 at spray nozzle 142. Spray nozzle 142 may be an air atomizing nozzle that provides a fine degree of atomizing with a pattern that may round, wide angle, flat or otherwise. In an alternate embodiment, a solid stream nozzle or airless nozzle may be used where air supply 146 is not required. In an alternate embodiment, atomizing assembly 138 could be a powder or solid distribution assembly. Liquid supply 148 and air supply 146 have disconnects 154 and 152 respectively allowing the supplies to be disconnected when enclosure 16 is being/>transported while still maintaining a sealed enclosure. Seal assembly 144 is provided in order to allow atomizing assembly 138 to be rotated about axis 156 or to allow atomizing assembly 138 to be moved axially in direction 150. Seal assembly 144 is shown as a dual lip type seals that seals on the diameter of extension 140. Alternately, seal assembly 144 may be o-rings, labyrinth seals, gas or fluid seals, clearance seals such as with a packing, bushing or other suitable seals. In alternate embodiments, more or less seals may be provided as in the case where seal assembly 144 is a single seal or multiple seals or no seals may be provided. In alternate embodiments, different geometry seals may be provided such as rectangular or otherwise.

Filter assembly 160 is shown extending through cover 56. Although filter assembly 160 is shown extending through cover 56, it could alternately extend through container 54 or otherwise. In an alternate embodiment, filter assembly 160 could not be provided. Filter assembly 160 is provided to allow gas to escape from enclosure 16 with any airborne contaminants being trapped. Filter assembly 160 includes filter 162, filter enclosure 164, baffle 166 and screen 168. Filter 162 may be a HEPA type filter that captures particles a 0.3 micron in size or larger. In an alternate embodiment, other filter types may be provided with smaller or larger particle capture ranges. Screen 168 may have a single screen or multiple screens with varying degrees of being coarse as shown. Screen 168 is used to prevent larger particles from entering the filter. In an alternate embodiment, screen 168 may not be provided.

Pressure gage 170 is shown extending through cover 56. Although pressure gage 170 is shown extending through cover 56, it could alternately extend through container 54 or otherwise. In an alternate embodiment, pressure gage 170 could not be provided. Pressure gage 170 is provided to allow pressure to be monitored of the interior of enclosure 16 in order to detect a fault, such as when filter 160 is clogged or otherwise. Pressure gage 170 may alternately have a pressure switch that activates an alarm in the event of an overpressure beyond a pressure set point. A diaphragm 174 may be provided to prevent larger particles from entering pressure gage 170.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A granulating machine for granulating a substance, the granulating machine comprising:
a support;
a container removably coupled to the support, the container having an interior region and an opening and being adapted to contain the substance;
a lid removably covering the opening of the container;
an impeller in the interior region, the impeller being adapted to mix the substance in the container; and
a chopper in the interior region, the chopper being adapted to chop the substance in the container;
wherein the container is removable from the support with the lid covering the container.

2. The granulating machine of claim 1 wherein the lid seals the container.

3. The granulating machine of claim 2 further comprising a filter; wherein the filter is adapted to allow a gas to escape from the interior region when the container is covered.

4. The granulating machine of claim 3 further comprising a pressure gauge; wherein the pressure gauge is adapted to detect when the filter is obstructed when the container is covered.

5. The granulating machine of claim 3 further comprising a shield; wherein the shield is adapted to prevent the substance from obstructing the filter.

6. The granulating machine of claim 1 further comprising a nozzle; wherein the nozzle is adapted to allow a liquid to be inserted into the interior region when the container is covered.

7. The granulating machine of claim 3 further comprising a nozzle; wherein the nozzle is adapted to allow a liquid to be inserted into the interior region when the container is covered.

8. The granulating machine of claim 1 wherein the substance may be loaded into the container or removed from the container when the lid is removed from the container.

9. The granulating machine of claim 1 wherein both the impeller and the chopper are rotateably coupled to the container.

10. The granulating machine of claim 1 wherein both the impeller and the chopper are rotateably sealed to the container.

11. The granulating machine of claim 1 further comprising a motor coupled to the support, the motor removably coupled to the impeller.

12. The granulating machine of claim 11 wherein the motor is removably coupled to the impeller with a fastener and wherein the fastener is removeable without removing the lid from the container.

13. A granulating enclosure for granulating a substance, the granulating enclosure comprising:
a container having an interior region and an opening and being adapted to contain the substance;
a lid removably covering the opening of the container;
an impeller in the interior region, the impeller being adapted to mix the substance in the container; and
a chopper in the interior region, the chopper being adapted to chop the substance in the container;
wherein the container is movable from a first location where the substance is granulated to a second location without removing the lid from the container.

14. The granulating enclosure of claim 13 wherein the lid seals the container.

15. The granulating enclosure of claim 14 further comprising a filter; wherein the filter is adapted to allow a gas to escape from the interior region when the container is covered.

16. The granulating enclosure of claim 15 further comprising a pressure gauge; wherein the pressure gauge is adapted to detect when the filter is obstructed when the container is covered.

17. The granulating enclosure of claim 15 further comprising a shield; wherein the shield is adapted to prevent the substance from obstructing the filter.

18. The granulating enclosure of claim 13 further comprising a nozzle; wherein the nozzle is adapted to allow a liquid to be inserted into the interior region when the container is covered.

19. The granulating enclosure of claim 15 further comprising a nozzle; wherein the nozzle is adapted to allow a liquid to be inserted into the interior region when the container is covered.

20. The granulating enclosure of claim 13 wherein the substance may be loaded into the container or removed from the container when the lid is removed from the container.

21. The granulating enclosure of claim 13 wherein both the impeller and the chopper are rotateably coupled to the container.

22. The granulating enclosure of claim 13 wherein both the impeller and the chopper are rotateably sealed to the container.

23. The granulating enclosure of claim 13 wherein the impeller is adapted to be removably coupled to a motor with a screw and wherein the screw is rotateable without removing the lid from the container.

24. A granulating enclosure for granulating a substance, the granulating enclosure comprising:
a container having an interior region and an opening and being adapted to contain the substance;
a lid removably sealing the container;
an impeller in the interior region, the impeller being adapted to mix the substance in the container; and
a filter being adapted to allow a gas to escape from the interior region when the container is covered.
wherein the container is moveable from a first location to a second location without removing the lid from the container.

25. The granulating enclosure of claim 24 further comprising a pressure gauge; wherein the pressure gauge is adapted to detect when the filter is obstructed when the container is covered.

26. The granulating enclosure of claim 24 further comprising a shield; wherein the shield is adapted to prevent the substance from obstructing the filter.

27. The granulating enclosure of claim 24 further comprising a nozzle; wherein the nozzle is adapted to allow a liquid to be inserted into the interior region when the container is covered.

28. The granulating enclosure of claim 24 wherein the impeller is adapted to be removably coupled to a motor with a screw and wherein the screw is rotateable without removing the lid from the container.

29. A method of granulating a substance comprising the steps of:
placing the substance into a container;
covering the container with a lid;
mixing the substance in the container at a first location with an impeller;
chopping the substance in the container with a chopper; and
moving the container from the first location to a second location without removing the lid from the container.

30. The method of granulating a substance of claim 29 wherein the step of covering the container with a lid further comprises sealing the container.

31. The method of granulating a substance of claim 30 further comprising the step of filtering a gas from the container.

32. The method of granulating a substance of claim 31 further comprising the step of detecting when the filter is obstructed with a pressure gauge.

33. The method of granulating a substance of claim 31 further comprising the step of shielding the filter from the substance to prevent the substance from obstructing the filter.

34. The method of granulating a substance of claim 29 further comprising the step of inserting a liquid into the container with a nozzle.

35. The method of granulating a substance of claim 31 further comprising the step of inserting a liquid into the container with a nozzle.

36. The method of granulating a substance of claim 29 further comprising the step of rotateably coupling the impeller and the chopper to the container.

37. The method of granulating a substance of claim 29 further comprising the step of rotateably sealing the impeller and the chopper to the container.

38. The method of granulating a substance of claim 29 further comprising the step of removably coupling a motor to the impeller with a screw wherein the screw is rotateable without removing the lid from the container.
